(19) United States
(12) Patent Application Publication
(10) Pub. No.: US 2026/0086549 A1
(43) Pub. Date: Mar. 26, 2026

(54) PREDICTIVE FAILURE ANALYSIS SYSTEM AND METHOD

(71) Applicants: Alexander Donald Birner, Corona, CA (US); Stanley Robert Warwarick, Sacramento, CA (US); Frederick Nathan Lietzman, Corona, CA (US)

(72) Inventors: Alexander Donald Birner, Corona, CA (US); Stanley Robert Warwarick, Sacramento, CA (US); Frederick Nathan Lietzman, Corona, CA (US)

(73) Assignee: Multimedia LED, Inc., Corona, CA (US)

(21) Appl. No.: 18/893,771

(22) Filed: Sep. 23, 2024

(51) Int. Cl. G05B 23/02

(52) U.S. Cl. CPC G05B 23/027; G05B 23/0283

(57) ABSTRACT

A predictive failure analysis system is operably connected with a data switch adapted to be operably connected with an electronics device to receive signals from sensors of the electronics device. The system performs the method steps of receiving signals from the sensor; tracking the signals to determine changes in the signals over time; determining the condition of the electronics device based upon the signals collected over time; and transmitting an alert when the condition of the electronics device has deteriorated to the point where the electronics device needs to be repaired or replaced.

### BACKGROUND OF THE INVENTION

### Field of the Invention

This invention relates generally to methods and systems for predictive failure analysis of electronics devices such as motors and actuators in various automated control system environments. More specifically, the invention pertains to a predictive failure analysis system that monitors and analyses the health of these devices, providing real-time data analysis, alert generation, and continuous improvement through a feedback loop.

### Description of Related Art

Many different industries involve complex machines, devices, systems, and workflows, in which operators must account for a host of parameters, metrics, and the like in order to optimize design, development, deployment, and operation of different technologies in order to improve overall results. This includes information about maintenance of various parts, and when such parts are to be inspected, repaired, and replaced. Historically, data has been collected in automated control system environments by humans, often recording batches of specific sensor data on media for later analysis.

Much maintenance is simply performed when a part fails; however, this can result in additional damage to other components when on part breaks, and also it can result in downtime while a part is being replaced. Furthermore, traditional systems may not account for the gradual degradation of sensor accuracy, leading to potential errors in data interpretation and subsequent system malfunctions.

There is a long-felt need in this field for a system to implement a software systems to monitor sensor data from various electronics devices in a system, and determine, sometimes using machine learning, when a part is going to need to be replaced, so that the part can be replaced proactively during regularly scheduled downtime periods. The present invention fulfills these needs and provides further advantages as described in the following summary.

### SUMMARY OF THE INVENTION

The present invention teaches certain benefits in construction and use which give rise to the objectives described below.

The present invention provides a predictive failure analysis system for monitoring electronics devices such as motors and actuators. The system can be deployed on a traditional computer platform, providing flexibility in implementation. When connected to a data switch or other form of network, the system integrates seamlessly with existing control systems to enhance operational reliability and prevent unexpected downtimes.

Another unique aspect of the present invention is its ability to monitor and record sensor drift in real-time. Sensor drift refers to the gradual deviation of a sensor's output from its true value over time, which can result from various factors such as environmental conditions, aging, or mechanical wear. The system continuously monitors sensor data to detect these gradual changes, allowing for early diagnosis and intervention before the drift impacts system performance. This feature not only ensures the accuracy and reliability of the control system but also extends the lifespan of sensors and related components.

In one embodiment, a predictive failure analysis system is operably connected with a data switch adapted to be operably connected with an electronics device to receive signals from sensors of the electronics device. The system performs the method steps of receiving signals from the sensor; tracking the signals to determine changes in the signals over time; determining the condition of the electronics device based upon the signals collected over time; and transmitting an alert when the condition of the electronics device has deteriorated to the point where the electronics device needs to be repaired or replaced.

In one embodiment, the predictive failure analysis system comprises a data collection system operably connected to sensors for detecting conditions of the electronic motor. The sensors produce a signal that varies over time and substantially corresponds with the condition of the motor. The data collection system further functions to transmit said signal. A machine learning software is included, being trained for determining a correlation between the signal and the condition of the electronic motor. An analysis server of the system includes a computer processor and a computer memory. The computer memory stores executable code that, when executed, performs a process comprising the steps of: receiving said signal from the data collection system; determining, via the machine learning software, the condition of the electronic motor; and transmitting an alert when the condition of the electronic motor has deteriorated to the point where the electronic motor needs to be replaced.

A primary objective of the present invention is to provide a predictive failure analysis system having advantages not taught by the prior art.

Another objective is to provide a predictive failure analysis that is able to alert maintenance crews to replace parts before they fail, avoiding component failures which may be costly and result in unexpected downtime.

Another objective is to provide a predictive failure analysis system that includes machine learning software for automatically detecting anomalies in an electronic motor.

A further objective is to provide a predictive failure analysis system that is adapted to monitor and manage multiple functional components at a time, for management of electronic motors, servos, and/or other devices.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is block diagram of a system that incorporates a predictive failure analysis system according to one embodiment of the present invention;

FIG. 2 is a flow diagram illustrating the function of the predictive failure analysis system of FIG. 1;

FIG. 3 is a flow diagram illustrating the operation of a system program of the predictive failure analysis system of FIG. 1; and

FIG. 4 is a block diagram illustrating a data collection system in relation to other components of the predictive failure analysis system.

### DETAILED DESCRIPTION OF THE INVENTION

The above-described drawing figures illustrate the invention, a predictive failure analysis system that monitors and analyses the health of electronic devices such as motors and actuators, and provides real-time data analysis, alert generation, and continuous improvement through a feedback loop.

The predictive failure analysis system may be used for monitoring electronics devices such as motors, actuators and any other similar devices, in particular in the field of automated control systems, although the teachings of this invention may be applied in other fields as well. The system monitors status data, as described below in more detail, to determine impeding failures of the electronics devices, and to initiate response protocols automatically based upon predictive analytics derived from continuous data evaluation.

The system may incorporate a modular dashboard designed for real-time monitoring and data visualization, aiding technicians in making maintenance decisions. The system is engineered to interface seamlessly with existing motor system outputs without the need for supplementary sensors, although this may be included as well if desired.

As described herein, the system can be deployed on a traditional computer platform, providing flexibility in implementation. When connected to a data switch or other form of network, the system integrates seamlessly with existing control systems to enhance operational reliability and prevent unexpected downtimes.

For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used.

The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The term “network” is defined to include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system. In this embodiment, the network 30 may be in the form of a network switch, but any form of network may be used, and should be within the scope of the present invention.

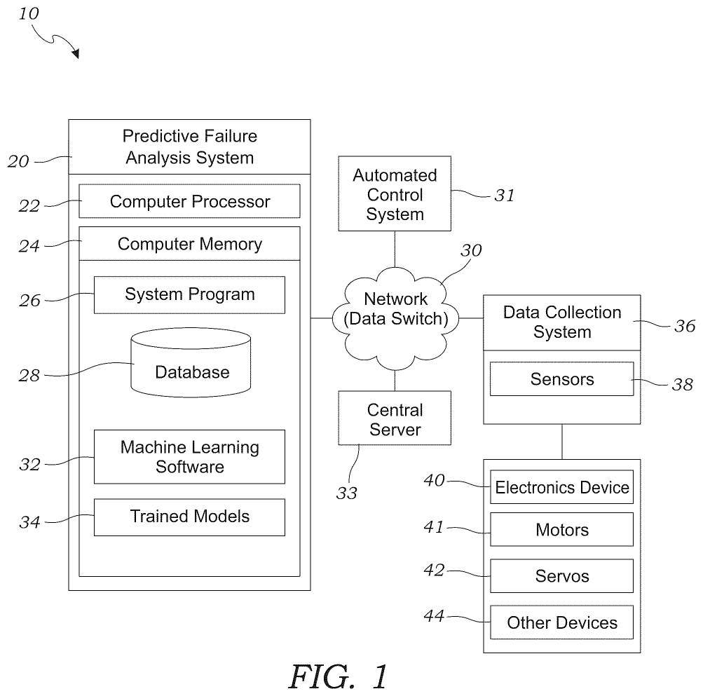

FIG. 1 is block diagram of a system 10 that incorporates a predictive failure analysis system 20 according to one embodiment of the present invention. In the embodiment of FIG. 1, the predictive failure analysis system 10 is embodied in computer device, server, or other form of computer or computers, as defined herein. The predictive failure analysis system 20 includes a computer processor 22 and a computer memory 24. The computer memory 24 stores executable code that, when executed, enables the predictive failure analysis system 20 to perform the processes described in greater detail below. In this embodiment, the computer memory 24 includes a system program 26 and a database 28 whose functions are discussed in greater detail below. The computer memory 24 may further include machine learning software 32 and trained models 34, also discussed below.

The predictive failure analysis system 20 is operably connected with a network 30 for operable connection with a data collection system 36, the data collection system 36 having sensors 38 which collect data from electronics devices 40, such as an electronic motor 41, servos 42, and other devices 44, as discussed below. In some embodiments, the sensors 38 further collect data from servos 42 and/or other devices 44, also discussed below. For example, in one embodiment the sensor is a multimeter, and the condition is a measurement of a voltage and/or current. Other forms of sensors 38, such as temperature sensors, vibration detection sensors, etc., may also be used, and any form of sensor known in the art should be considered within the scope of the present invention.

In addition to the software components stored in the computer memory 24, the predictive failure analysis system 20 may also be operatively connected with a wide variety of third-party service providers, such as data storage systems, data processing systems, AI processing systems, and other related systems, such as is known to one skilled in the art. Providing various data processing processes, in whole or in part, via third party platforms, is well known in the art, and such implementations should be considered within the scope of the present invention.

The predictive failure analysis system 10 may be used in conjunction with an automated control system 31, such as is commonly used for controlling animatronics devices, and similar robots and related systems, or any other equivalent system that may be compatible with this system 10. The system 10 may also work in conjunction with a central server 33, which may coordinate and oversee the function of a number of systems 10 distributed anywhere in the world. The central server 33 has a construction that is well known in the art, and utilizes software that functions as described in greater detail below.

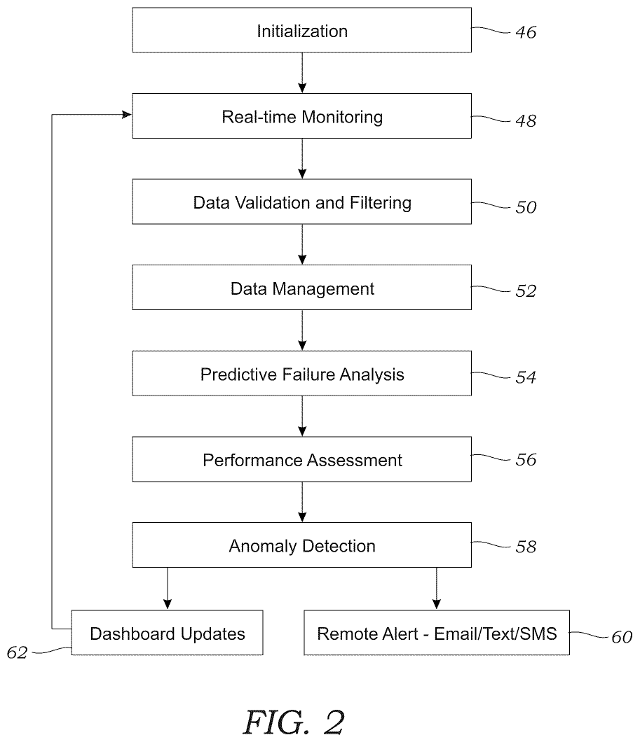

FIG. 2 is a flow diagram illustrating the function of the predictive failure analysis system 20 of FIG. 1. As shown in FIG. 2, at a first step, an initialization process 46 is commenced, to begin real-time monitoring 48 of the sensors 38 of the electronic device 40 (as shown in FIG. 1). As data is received, it goes through a data validation and filtering process 50, wherein the data is received, filtered, and validated. A data management 52 process follows, and then predictive failure analysis 54 may be conducted, to enable a performance assessment step 56, and leading finally to an anomaly detection 58 step.

When the collected data matches patterns that are recognized as indicating failure of the electronic device 40 (e.g., from wear, overheating, damage, etc.) the system 10 sends a remote alert 60 to a person monitoring the system 10. The person may receive a text, email, call, or any form of alert transmittal, so the anomaly can be addressed. In some uses, the system 10 may be adapted to automatically attempt to resolve anomalies, wherein the alert 60 is a notification that does not require action on the part of the recipient.

The system 20 further initiates dashboard updates 62, wherein a monitoring dashboard displays the data, along with any detected anomaly and/or alert. The dashboard may be in the form of a control panel, webpage, monitor array, or any other suitable form of monitoring dashboard known in the art. Once the dashboard is updated, the system 10 continues real time monitoring steps 48 through 60 of the process, to continue to monitor, send alerts, and update the dashboard.

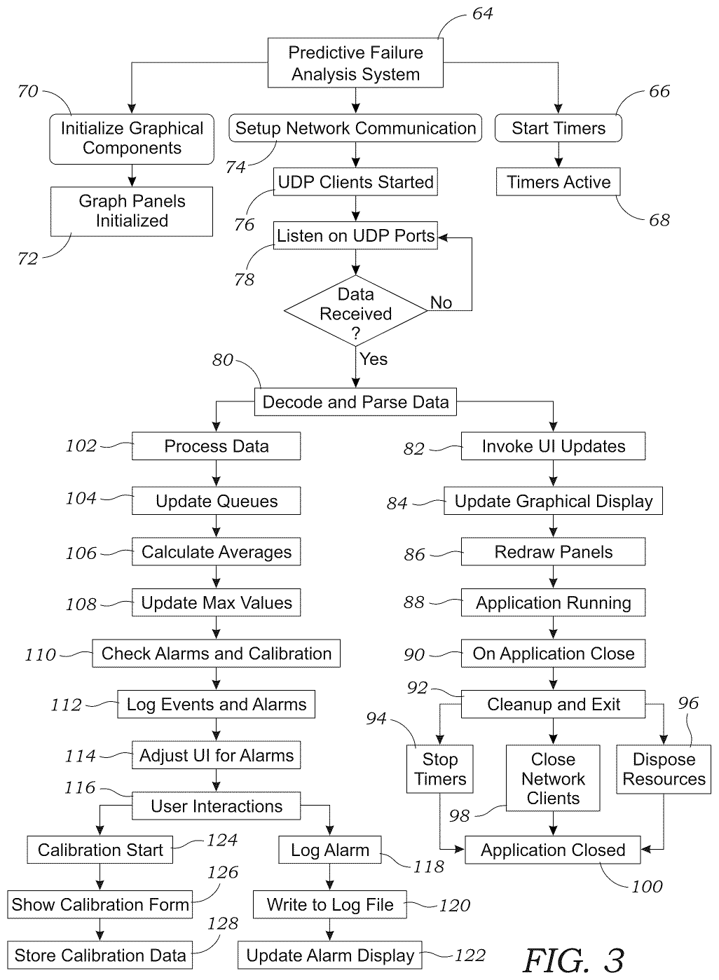

FIG. 3 is a flow diagram illustrating the operation of the system program 26 of the system of FIG. 1. As shown in FIG. 3, following startup in step 64, the system program 26 initiates multiple processes. First, timers 66 are started, which results in a timers active 70 state during the functioning of the system program 26. At this startup phase, graphical components are also initialized in step 70, and graphic panels are also initialized in step 72.

Following network communications setup in step 74, the system program 26 starts UDP clients in step 76, and then UDP ports may be monitored in step 78. If data is not received, step 78 is repeated. If data is received, a decode and parse data 80 process begins, initializing a pair of simultaneous processes. In one process, an invoke UI updates 82 step precedes an update graphical display 84 step. Next steps include redraw panels 86, application running 88, on application close 90, and cleanup and exit 92. At this point, simultaneous processes include stop timers 94, close network clients 98, and dispose resources 96, terminating in application closed 100.

In the other of the pair of simultaneous processes, a process data 102 step precedes an update queues 104 step. Next steps include calculate averages 106, update max values 108, check alarms and calibration 110, log events and alarms 112, adjust UI for alarms 114, and user interactions 116. At this point, a pair of simultaneous processes begin. In one process, log alarm 118 precedes write to log file 120, terminating in update alarm display 122. In the other process, calibration start 124 precedes show calibration form 126, terminating in store calibration data step 128 (i.e., in the database 28).

While singular examples of the function and operation processes of the system 10 are shown and described, many alternative and/or additional steps may be implemented, and some steps may be excluded. The processes shown are intended only for the purpose of example, and any function or operation processes may be implemented, provided they are within the scope of the presented claims.

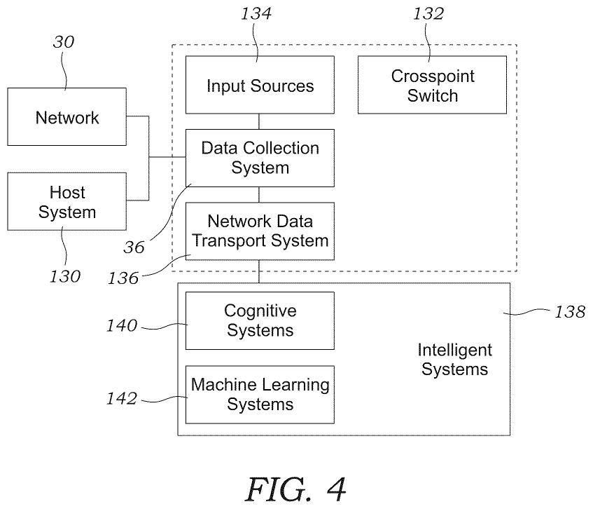

FIG. 4 is a block diagram illustrating the data collection system 36 in relation to other components of the predictive failure analysis system 10. As shown in FIG. 4, the data collection system 36 receives data from input sources 134 (e.g., sensors and any other input sources), and is also able to communicate with host system 130. In this embodiment, the data collection system 36 is also able to communicate via a network data transport system 136 an intelligent systems module 138, the module including cognitive systems 140 and machine learning systems 142.

The predictive failure analysis system 10 is adapted for monitoring a functional component of an animatronic system (e.g., the electronics devices 40. As illustrated, the data collection system 36 is operably connected to the sensors 38 for detecting conditions of the functional component. The sensors 38 produce a signal that varies over time and substantially corresponds with the condition of the functional component. The data collection system 36 further functions to transmit said signal to the analysis predictive failure analysis system 20 via the network 30.

The machine learning software 32 is trained for determining a correlation between the signal and the condition of the functional component. As discussed, the analysis predictive failure analysis system 20 includes the computer processor 22 and the computer memory 24, the computer memory 24 storing executable code that, when executed, performs the processes illustrated in FIGS. 2-3. In other language, the processes include receiving the signal from the data collection system 36, and determining, via the machine learning software 32 (and/or the intelligent systems 138), the condition of the functional component. The alert 60 is transmitted when the condition of the functional component has deteriorated to the point where the functional component needs to be replaced.

Sensor drift monitoring is another innovative feature of the system 10. The system 10 continuously tracks the readings from various sensors, comparing them against established baselines to identify any gradual deviations. By detecting sensor drift early, the system 10 can alert maintenance teams to recalibrate or replace affected sensors before their performance significantly deteriorates. This proactive approach enhances the overall reliability and efficiency of the automated control system 10, ensuring that accurate data is always available for decision-making processes. Sensor drift monitoring may improve accuracy by ensuring that sensor data remains accurate over time. It may also include the benefit of early for timely maintenance actions, reducing the risk of unexpected failures and downtime. Furthermore, sensor drift monitoring may extend the lifespan of various sensors, wherein regular monitoring and calibration of sensors can extend their operational life, reducing replacement costs. Maintaining accurate sensor readings ensures that automated control systems operate at optimal efficiency, improving overall performance.

In some embodiments, the electronic device 40 may be monitored to determine a measurement of voltage to the electronic device 40, a measurement of current drawn (amp draw), a measurement of temperature, a measurement of vibration, operational cycles completed, and/or any other measurements that may indicate a functional condition of the electronic device 40. The system 10 may be adapted to utilize existing, built-in sensors 38 of the functional component(s), so that it may be seamlessly integrated with existing systems.

In some embodiments, the system monitors sensor data for spikes or sudden drops in any of these measurements which exceed predetermined thresholds. In other embodiments, the system monitors gradual changes over time, and signals an alert once sensor data gradually reaches a certain point.

For example, in one example, a method of predicting an anomaly from vibration data may include a set of operational steps including capturing vibration data from at least one vibration sensor disposed to capture vibration of a portion of the functional component. The captured vibration data may be processed to determine at least one of a frequency, amplitude, a force of the vibration, and/or changes to vibrational patterns over time.

The system may include machine learning based pattern recognition based on the fusion of remote, analog industrial sensors or machine pattern analysis of state information from multiple analog industrial sensors to provide anticipated condition information for the system 10. In some embodiments, the present invention includes the machine learning software 32 and the intelligent systems 138 that utilize trained models 34 (in FIG. 1) to determine patterns in sensor data, from one or more sensors, to predict failure of any component, and then update the dashboard to indicate that a part needs replacement, and/or send an alert to replace the part, especially if failure becomes imminent.

The system may support a wide range of communication protocols commonly used in legacy systems, such as BACnet, CAN bus, Ethernet/IP, Modbus, MQTT, OLE, OPC UA, POC, PROFINET, etc., for process control, and various proprietary protocols, to facilitate use of the system with existing systems and limit costs. E-log functionality maintains time-stamped records of errors, shutdown interruptions, and sensor drift, integrated with the legacy system for seamless access and review. Maintenance actions and their outcomes are documented and fed back into the system, enhancing its predictive capabilities. Machine learning models may be continuously updated to account for added information, allowing the system to improve over time, and to adapt to the specific operational patterns of the legacy equipment.

The system is modular, allowing it to expand and integrate additional modules as the scale of the operation grows. The system can be deployed across multiple servers, distributing the computational load. The system can also leverage cloud computing resources to scale dynamically based upon operational load. The system employs robust data storage solutions to handle large datasets, using databases optimized for high speed read/write operations. Data compression and aggregation techniques are used to manage bandwidth and storage requirements.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A predictive failure analysis system for monitoring an electronics device having a sensor capable of generating a signal that varies over time and substantially corresponds with the condition of the electronics device, the predictive failure analysis system comprising:
a data switch adapted to be operably connected with the electronics device to receive signals from the sensor of the electronics device;
the data switch being operably connected with a computer processor and a computer memory; and
the computer memory storing executable code that, when executed, performs a process comprising the steps of:
receiving signals from the sensor;
tracking the signals to determine changes in the signals over time;
determining the condition of the electronics device based upon the signals collected over time; and
transmitting an alert when the condition of the electronics device has deteriorated to the point where the electronics device needs to be repaired or replaced.

2. The predictive failure analysis system of claim 1, wherein the sensor is a multimeter operably connected with the predictive failure analysis system, and measurements of voltage of the electronics device are used to determine the condition of the electronics device.

3. The predictive failure analysis system of claim 1, wherein the sensor is a multimeter operably connected with the predictive failure analysis system, and measurements of current drawn by the electronics device are used to determine the condition of the electronics device.

4. The predictive failure analysis system of claim 1, wherein the sensor is a temperature sensor operably connected with the predictive failure analysis system, and measurements of temperature of the electronics device are used to determine the condition of the electronics device.

5. The predictive failure analysis system of claim 1, wherein the sensor is a vibration sensor operably connected with the predictive failure analysis system, and measurements of vibration of the electronics device are used to determine the condition of the electronics device.

6. The predictive failure analysis system of claim 1, wherein tracking a number of operational cycles of the electronics device is used to determine the condition of the electronics device.

7. The predictive failure analysis system of claim 1, further comprising a machine learning software trained for determining a correlation between the signal and the condition of the electronic motor, and wherein the determination of the condition of the electronic device is made with reference to the machine learning software.

8. The predictive failure analysis system of claim 1, wherein the executable code operably installed in the computer memory of the predictive failure analysis system includes a system program and a database.

9. A predictive failure analysis system for monitoring an electronics device, the predictive failure analysis system comprising:
a data collection system operably connected to at least one sensor for detecting a condition of the electronics device, the sensor producing a signal that varies over time and substantially corresponds with the condition of the electronics device, the data collection system further functioning to transmit said signal;
a computer processor and a computer memory, the computer memory storing executable code that, when executed, performs a process comprising the steps of:
receiving said signal from the data collection system;
determining the condition of the electronics device; and
transmitting an alert when the condition of the electronics device has deteriorated to the point where the electronics device needs to be repaired or replaced.

10. The predictive failure analysis system of claim 9, wherein the sensor is a multimeter, and the condition is determined based upon measurements of voltage drawn by the electronics device.

11. The predictive failure analysis system of claim 9, wherein the condition is a measurement of current to the electronics device.

12. The predictive failure analysis system of claim 9, wherein the condition is a temperature.

13. The predictive failure analysis system of claim 9, wherein the condition is a measurement of vibration.

14. The predictive failure analysis system of claim 9, wherein the condition is a measurement of number of operational cycles completed.

15. The predictive failure analysis system of claim 9, further comprising a machine learning software trained for determining a correlation between the signal and the condition of the electronic motor, and wherein the determination of the condition of the electronic device is made with reference to the machine learning software.

16. The predictive failure analysis system of claim 9, wherein the executable code operably installed in the computer memory of the predictive failure analysis system includes a system program and a database.

17. A predictive failure analysis system for monitoring an electronics device, the predictive failure analysis system comprising:
a data collection system operably connected to at least one sensor for detecting conditions of the electronics device, the sensor producing a signal that varies over time and substantially corresponds with the condition of the electronics device, the data collection system further functioning to transmit said signal;
wherein the sensor is a multimeter, and the condition is a measurement of a voltage or current;
a machine learning software trained for determining a correlation between the signal and the condition of the electronic motor; and
a computer processor and a computer memory, the computer memory storing executable code that, when executed, performs a process comprising the steps of:
receiving said signal from the data collection system;
determining, via the machine learning software, the condition of the electronics device; and
transmitting an alert when the condition of the electronics device has deteriorated to the point where the electronics device needs to be repaired or replaced.
